(19) United States
(12) Patent Application Publication
(10) Pub. No.: US 2005/0234618 A1
(43) Pub. Date: Oct. 20, 2005

(54) Conversion interface of car audiovisual satellite navigation system

(76) Inventor: Shang-Ming Chi, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/068,770

(22) Filed: Mar. 2, 2005

(30) Foreign Application Priority Data
Mar. 5, 2004 (TW) 93203323

(51) Int. Cl. G06F 17/00

(52) U.S. Cl. 701/36; 701/1

(57) ABSTRACT

A conversion interface is connected between a car audiovisual satellite navigation system and an external navigation device. The conversion interface has a video conversion device and a video control device. The video conversion device converts a video input by the external navigation device into a video conforming to a format that can be displayed by the car audiovisual satellite navigation system. The video control device decodes a keystroke signal of the car audiovisual satellite navigation system to determine whether to output internal video data of the car audiovisual satellite navigation system or video data input by the external navigation device to a display panel.

### BACKGROUND OF THE INVENTION

1. Field of the invention

The present invention relates to a conversion interface of a car audiovisual satellite navigation system and, more particularly, to a conversion interface capable of switching to display an internal video of a car audiovisual satellite navigation system or a video from an external input.

2. Description of Related Art

In addition to the enhancement of car's driving performance, the development of today's car industry is gradually emphasizing multi-functional recreation provided for driver by equipment in the car. For example, car audiovisual navigation systems are multimedia audiovisual playing platforms that integrate satellite traffic navigation and acoustics control. These car audiovisual navigation systems are usually mounted in high-class imported cars.

As shown in FIG. 1, a car audiovisual satellite navigation system 7 comprises a control host 71, a control panel 73, a satellite navigation device 75, an audiovisual play device 77 and a display panel 79. Because cars are generally designed mainly for the local market, the satellite navigation device 75 is integrated with local map data to provide satellite traffic navigation.

The above car audiovisual satellite navigation system 7, however, often neglects the requirements of other markets. No map data of other countries are built in the satellite navigation device 75. Therefore, cars equipped with this car audiovisual satellite navigation system 7 can provide satellite traffic navigation only in regions conforming to the map data. This phenomenon usually occurs in high-class imported cars in the market.

In order to solve the above problem, extra equipment is installed. Reference is made to FIG. 1 again. A TV tuner 83 is externally connected to an input interface 81 of the car audiovisual satellite navigation system 7. The TV format in European countries is PAL, while the TV format in most Asian countries is NTSC. This TV tuner 83 provides video format conversion between the PAL and NTSC formats. Moreover, the signal of the TV tuner 83 is from an external satellite navigation device 85. The external satellite navigation device 85 can provide map data of the region where the car is and satellite traffic navigation.

The above method makes use of the TV tuner 83 and the external satellite navigation device 85 to provide satellite traffic navigation. Although the problem that there is no local map data built in the car audiovisual satellite navigation system can be solved, the satellite traffic navigation video directly input to the car audiovisual satellite navigation system is not compatible with the full function of navigation operation and acoustics control originally provided by the car audiovisual satellite navigation system. In other words, when operating the satellite navigation function, the driver can't listen to the music played by the car audiovisual satellite navigation system.

### SUMMARY OF THE INVENTION

An object of the present invention is to provide a conversion interface for a car audiovisual satellite navigation system so that the driver can listen to music while performing the operation of traffic navigation.

In order to achieve the above object, the present invention provides a conversion interface of a car audiovisual satellite navigation system capable of switching to display a first video data of the car audiovisual satellite navigation system or a second video data from an external input. The conversion interface comprises a video conversion device and a video control device. The video conversion device is used for converting the second video data into a video format that can be displayed by the car audiovisual satellite navigation system. The video control device is electrically connected to the video conversion device for decoding a keystroke signal of the car audiovisual satellite navigation system to determine whether to output the first video data or the second video data.

To achieve the above object, the present invention also provides a conversion interface of a car audiovisual satellite navigation system. The conversion interface is electrically connected between the car audiovisual satellite navigation system and an external satellite navigation device. The car audiovisual satellite navigation system comprises a control host, a control panel, a satellite navigation device, an audiovisual play device and a display panel. The conversion interface comprises a video conversion device and a video control device. The video conversion device is electrically connected to the external satellite navigation device for providing video format conversion so that the output video of the external satellite navigation device can conform to a format that can be displayed by the car audiovisual satellite navigation system. The video control device is used for decoding a keystroke signal of the control panel to select either the output video of the control host or that of the video conversion device to the display panel.

### BRIEF DESCRIPTION OF THE DRAWINGS

The various objects and advantages of the present invention will be more readily understood from the following detailed description when read in conjunction with the appended drawing, in which:

FIG. 1 is a block diagram of a conventional car audiovisual satellite navigation system with an external satellite navigation device;

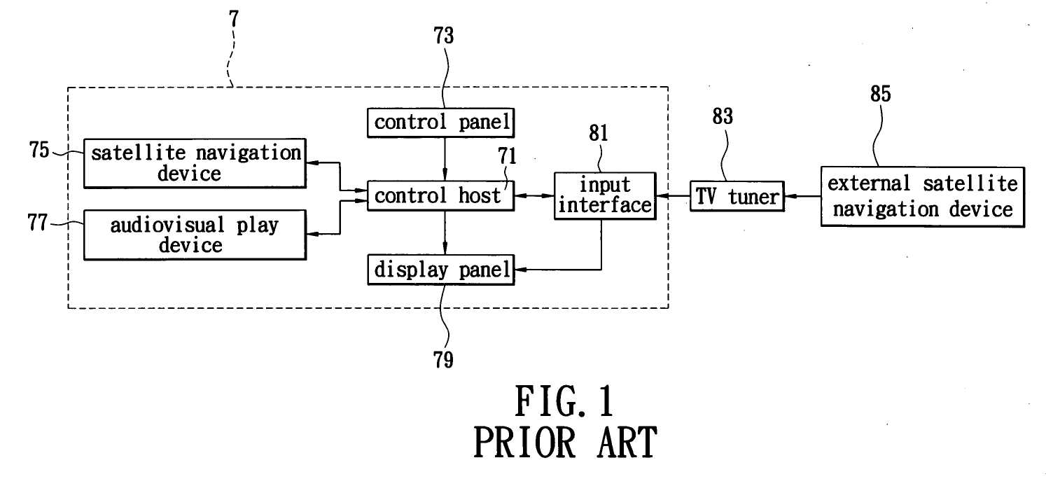

FIG. 2 is a block diagram of a conversion interface of a car audiovisual satellite navigation system of the present invention with an external satellite navigation device;

FIG. 3 is a block diagram of a video control device in a conversion interface of the present invention; and

FIG. 4 is a block diagram of a video conversion device in a conversion interface of the present invention.

### DETAILED DESCRIPTION OF THE PREFERRED EMBODIMENTS

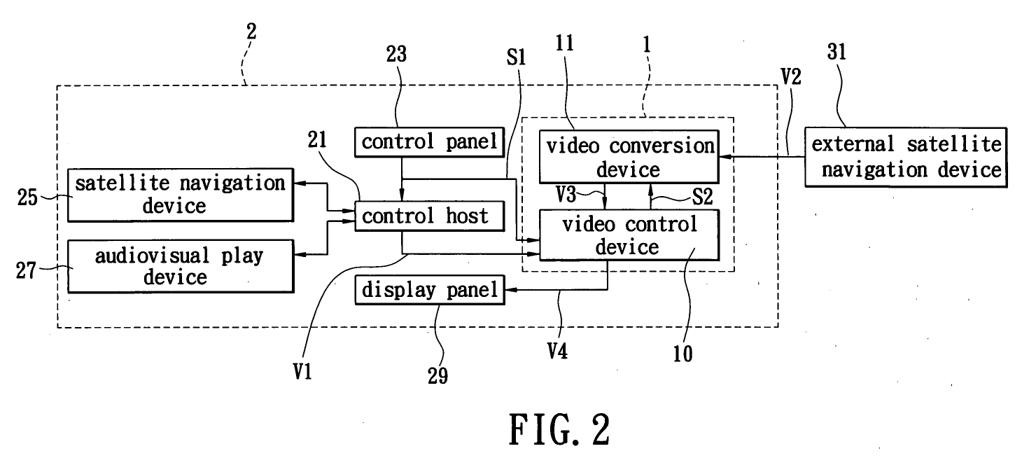

As shown in FIG. 2, a conversion interface 1 is connected between a car audiovisual navigation system 2 and an external satellite navigation device 31. The conversion interface 1 is integrated with the car audiovisual navigation system 2, and is compatible with the operation of the car audiovisual navigation system 2. The primary object of the present invention is to allow the car audiovisual navigation system 2 to provide satellite navigation and play music, simultaneously. The satellite navigation is accomplished with an external device when the car audiovisual navigation system 2 has no local map data built therein.

The car audiovisual navigation system 2 comprises a control host for providing various operations, a control panel 23 for providing key input, a satellite navigation device 25 for providing traffic navigation, an audiovisual play device 27 for providing acoustics and video playing, and a display panel. 29.

The conversion interface 1 comprises a video control device 10 and a video conversion device 11. The video control device 10 is electrically connected to output terminals of the control panel 23 and the control host 21, and separately gets a keystroke signal S1 and a first video data V1. This first video data V1 is generated in the car audiovisual navigation system 2, and corresponds to the key input of the control panel 23 such as an operation frame when listening to music, a system idle frame, or a video playing frame.

The external satellite navigation device 31 is electrically connected to the video conversion device 11. The video conversion device 11 receives a second video data V2 output by the external satellite navigation device 31, and converts the second video data V2 into a third video data conforming to a format that can be displayed by the car audiovisual navigation system 2.

The video control device 10 outputs a fourth video data V4 to a display panel 29. Whether the first video data V1 or the third video data V3 is output to the display panel 29 is determined according to the keystroke signal S1. That is, this fourth video data V4 is either the first video data V1 or the third video data V3.

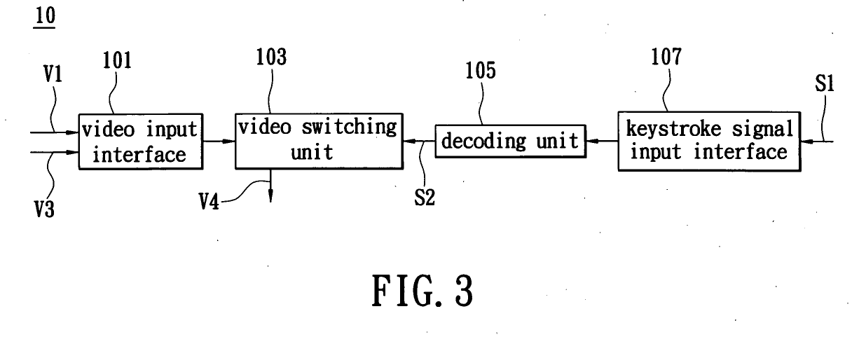

As shown in FIG. 3, a keystroke signal input interface 107 in the video control device 10 receives the keystroke signal S1 output by the control panel 23. A decoding unit 105 electrically connected to the output terminal of the keystroke signal input interface 107 decodes the keystroke signal S1 to get a keystroke decoding signal S2. A video input interface 101 receives the first video data V1 and the third video data V3. A video switching unit 103 selects either the first video data V1 or the third video data V3 for output to the display panel 29 according to the keystroke decoding signal S2.

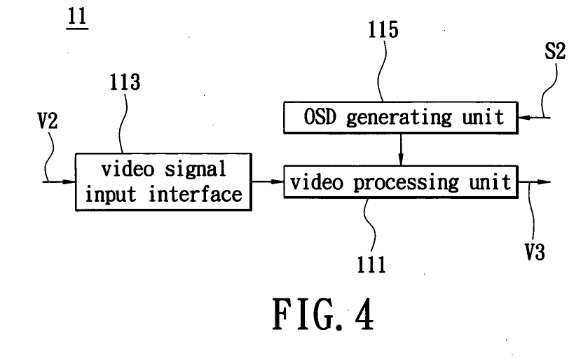

As shown in FIG. 4, a video signal input interface 113 in the video conversion device 11 receives the second video data V2. A video processing unit 111 electrically connected to the output terminal of the video signal input interface 113 performs video format conversion (e.g., from PAL to NTSC) to obtain the third video data V3 mentioned above. An OSD generating unit 115 in the video conversion device 11 receives the keystroke decoding signal S2 output by the decoding unit 105, and determines whether to output an OSD message frame to the video processing unit 111 according to the keystroke decoding signal S2 so that the third video data V3 output by the video processing unit 111 includes the OSD message frame.

The conversion interface 1 of the present invention first determines whether to output the first video data V1 or the third video data V3 (obtained by performing video format conversion to the second video data V2) to the display panel 29 according to the keystroke signal S1 output by the control panel 23. For example, when traffic navigation is provided to the car audiovisual navigation system 2 by the external satellite navigation device 31, if the driver wants to listen to music at the same time, he can operate the control panel 23 to play music. Because there is no need for video output when playing music, the conversion interface 1 judges that the keystroke signal S1 of the control panel 23 represents the action of playing music and thus selects the third video data V3 and outputs it to the display panel 29. This third video data V3 is a traffic navigation video. On the other hand, the control host 21 controls the audiovisual play device 27 to play music. The driver therefore can listen to music during traffic navigation.

Subsequently, if the control panel 23 plays video, the conversion interface 1 judges that the keystroke signal S1 of the control panel 23 represents the action of playing video and thus switches the third video data V3 to the first video data V1 to display the video provided from within the car audiovisual navigation system 2.

To sum up, the present invention makes use of the external satellite navigation device 31 to provide a local map data for navigation when the car audiovisual navigation system 2 has no local map data built therein, thereby accomplishing simultaneous functions of traffic navigation and playing music.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A conversion interface of a car audiovisual satellite navigation system capable of switching to display a first video data of said car audiovisual satellite navigation system or a second video data from an external input, said conversion interface comprising:
a video conversion device for converting said second video data into a video format for display by said car audiovisual satellite navigation system; and
a video control device electrically connected to said video conversion device for decoding a keystroke signal of said car audiovisual satellite navigation system to determine whether to output said first video data or said second video data.

2. The conversion interface of a car audiovisual satellite navigation system as claimed in claim 1, wherein said video conversion device comprises:
a video signal input interface for receiving said second video data; and
a video processing unit electrically connected to said video signal input interface for performing video format conversion to said second video data.

3. The conversion interface of a car audiovisual satellite navigation system as claimed in claim 2, further comprising an OSD generating unit, wherein the OSD generating unit is electrically connected to said video processing unit for displaying an OSD message frame on the video output by said video processing unit.

4. The conversion interface of a car audiovisual satellite navigation system as claimed in claim 1, wherein said video control device comprises:
a keystroke signal input interface for receiving said keystroke signal of said car audiovisual satellite navigation system;
a video input interface for receiving said first video data of said car audiovisual satellite navigation system and the video output by said video conversion device;
a decoding unit electrically connected to said keystroke signal input interface for decoding said keystroke signal; and
a video switching unit electrically connected to said decoding unit for switching and outputting a video received by said video input interface to a display panel of said car audiovisual satellite navigation system according to the decoding result of said keystroke signal.

5. A conversion interface of a car audiovisual satellite navigation system, said conversion interface being electrically connected between said car audiovisual satellite navigation system and an external satellite navigation device, said car audiovisual satellite navigation system comprising a control host, a control panel, a satellite navigation device, an audiovisual play device and a display panel, said conversion interface comprising:
a video conversion device electrically connected to said external satellite navigation device for providing video format conversion so that an output video of said external satellite navigation device conforms to a format for display by said car audiovisual satellite navigation system; and
a video control device for decoding a keystroke signal of said control panel to select either an output video of said control host or an output video of said video conversion device for display on said display panel.

6. The conversion interface of a car audiovisual satellite navigation system as claimed in claim 5, wherein said video conversion device comprises:
a video signal input interface for receiving the output video of said external satellite navigation device; and
a video processing unit electrically connected to said video signal input interface for performing video format conversion on the output video of said external satellite navigation device.

7. The conversion interface of a car audiovisual satellite navigation system as claimed in claim 6, further comprising an OSD generating unit, wherein the OSD generating unit is electrically connected to said video processing unit for displaying an OSD message frame on the video output by said video processing unit.

8. The conversion interface of a car audiovisual satellite navigation system as claimed in claim 5, wherein said video control device comprises:
a keystroke signal input interface for receiving said keystroke signal of said control panel;
a video input interface for receiving the output videos of said control host and said video conversion device;
a decoding unit electrically connected to said keystroke signal input interface for decoding said keystroke signal; and
a video switching unit electrically connected to said decoding unit for switching and outputting a video received by said video input interface to said display panel according to the decoding result of said keystroke signal.
